(19) United States
(12) Patent Application Publication
(10) Pub. No.: US 2007/0097837 A1
(43) Pub. Date: May 3, 2007

(54) Use of external optical feedback in a laser to generate a data signal

(76) Inventors: Daniel R. Marshall, Boise, ID (US); David K. Towner, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,327

(22) Filed: Oct. 31, 2005

(51) Int. Cl. G11B 7/00

(52) U.S. Cl. 369/116

(57) ABSTRACT

Disclosed are various systems and methods for generating a data signal. In one embodiment, a system is provided that comprises a laser with a gain medium, the laser being configured to emit optical power. The laser is further configured to receive an external optical feedback optically coupled into the gain medium from an optical medium. The external optical feedback is modulated by data embodied in the optical medium. A circuit generates the data signal corresponding to the data based upon a variation in the optical output power of the laser due to the external optical feedback directed into the gain medium of the laser.

### BACKGROUND

Lasers are employed to read data from and write data to optical data storage media such as compact discs and the like. Lasers may also be employed to write a label to a label surface of such optical media. In a typical optical media drive such as an optical disc drive, lasers generate an optical power output that is directed to the media. Such drives also typically employ various sensors to read data from the optical media. For example, assuming that an optical medium is an optical disc, there may be a series of “lands” and “pits” or other data marks that embody data stored on the optical disc. The lands reflect the laser light toward sensors with a reference amplitude and a reference phase, whereas the pits reflect the laser light toward these sensors with a modified amplitude and a modified phase. Data marks may also have the form of areas of altered phase in a phase change material. The phase of the recording material may be changed from amorphous to crystalline, or from crystalline to amorphous, during data recording. By angling the trajectory of the laser toward the optical disc, or by the use of beam splitting optics, laser light emitted by the laser may be reflected by the lands and pits of the optical disc, and captured by the sensors. In this respect, reflected laser light may represent a data signal having transitions between a state produced by lands and a state produced by pits. The timing of these data signal transitions relative to a reference signal produced by a data clock is used to generate a digital data stream corresponding to the encoded information stored on the disk. The use of sensors and beam splitting optics as described above present a relatively significant expense when optical storage devices are mass produced.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of an optical disc drive according to various embodiments of the present invention;

FIG. 2 is a drawing of a laser employed in the optical disc drive of FIG. 1 according to an embodiment of the present invention; and

FIG. 3 is a graph of a laser power output versus laser drive current input that illustrates a threshold current associated with the laser of FIG. 2 according to various embodiments of the present invention.

### DETAILED DESCRIPTION

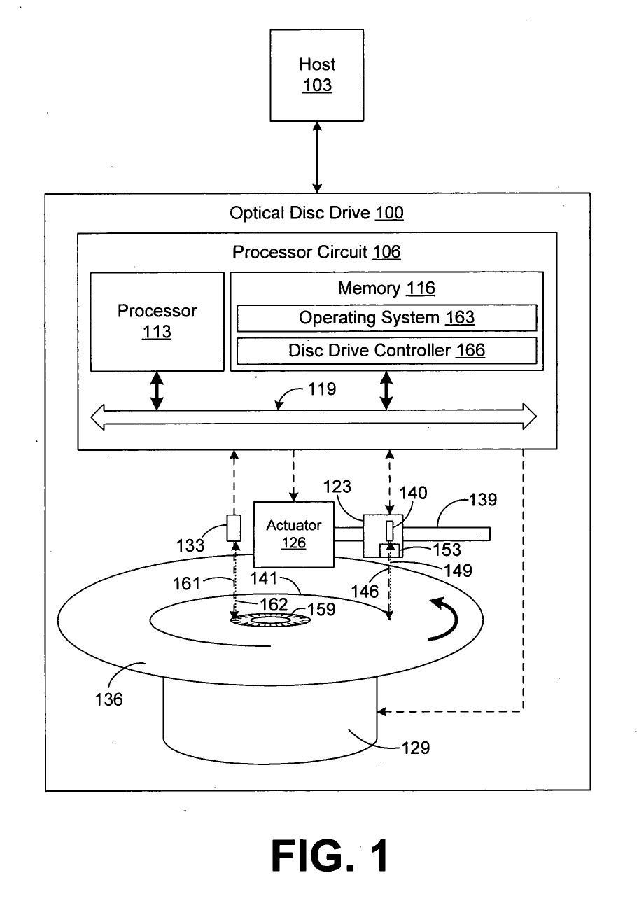

With reference to FIG. 1, shown is an optical disc drive 100 according to an embodiment of the present invention. The optical disc drive 100 is in data communication with a host 103. The host 103 may be, for example, a computer system, server, or other similar device. The optical disc drive 100 may or may not be enclosed within the enclosure of the host 103. For the purposes of the following discussion, first the structural aspects of the optical disc drive 100 are discussed. Thereafter, the operation of the optical disc drive 100 is discussed with particular focus on the operation of the laser in generating a data signal corresponding to data embodied on an optical medium according to the various embodiments of the present invention.

In one embodiment, the optical disc drive 100 includes a processor circuit 106. The processor circuit comprises a processor 113 and a memory 116, both of which are coupled to a local interface 119. In this respect, the local interface 119 may be, for example, a data bus with an accompanying control/address bus as can be appreciated by those with ordinary skill in the art. The optical disc drive 100 further includes an optical pickup unit 123, an actuator 126, and a spindle 129. According to various embodiments, the optical disc drive 100 also includes a rotational position laser sensor 133. When in use, an optical disc 136 is placed on the spindle 129 as shown. The optical pickup unit 123, actuator 126, spindle 129, and rotational position laser sensor 133 are all operatively or electrically coupled to the processor circuit 106. In particular, these components are coupled to the processor circuit 106 by way of an electrical connection through which electrical signals may be received from or transmitted to the processor circuit 106 in orchestrating the operation of the optical disc drive 100 as will be described. In one implementation, the optical pickup unit 123, actuator 126, spindle 129, and the rotational position laser sensor 133 are coupled to the local interface 119 through appropriate interface circuitry (not shown) as can be appreciated.

The actuator 126 may comprise, for example, a stepper motor or other such device. The actuator 126 is operatively coupled to the optical pickup unit 123, for example, using a screw shaft 139. In this respect, the actuator 126 may be manipulated by the processor circuit 106 in order to move the optical pickup unit 123 back and forth along the length of the screw shaft 139 during the normal operation of the optical disc drive 100 as will be described. In this respect, the actuator 126 positions the optical pickup unit 123 relative to the optical disc 136 during the normal course of operation of the optical disc drive 100. Alternatively, other approaches may be employed to move the optical pickup unit 123 as desired beyond a screw shaft 139.

The optical pickup unit 123 includes a laser assembly 140 that may be employed to read data from and, in some embodiments, to write data to a track 141 of the optical disc 136. The laser assembly 140 and the rotational position laser sensor 133 may each comprise, for example, a laser diode or other type of laser. While the use of the laser assembly 140 is described in the context of the optical disc drive 100, it is understood that the laser assembly 140 may be employed in optical data storage devices other than an optical disc drive as can be appreciated. In this respect, the optical disc 136 is one example of the various types of optical media that may be employed according to the various embodiments of the present invention.

In the context of the optical disc drive 100, the laser assembly 140 is controlled to generate laser light 146 that is directed to the optical disc 136. The laser assembly 140 may operate at any one of a number of optical wavelengths as can be appreciated by those with ordinary skill in the art. At least a portion of the laser light 146 may reflect off the optical disc 136 as reflected laser light 149. Data structures are embodied in the optical disc 136 that reflect the laser light 146 as can be appreciated by those with ordinary skill in the art.

The optical pickup unit 123 further comprises a lens focus actuator 153 that controls the focus of a lens. In this respect, the lens focus actuator 153 adjusts the position of the lens in relation to the optical disc 136 in response to a focus error signal, value, or other input setting. The lens focus actuator 153 is operatively coupled to the processor circuit 106 that provides the focus error signal or data to the lens focus actuator 153.

The laser assembly 140 also detects reflected laser light 149 during a read operation and generates a voltage signal that is applied to the processor circuit 106. The magnitude of the voltage signal generated by the laser assembly 140 is generally proportional to the magnitude of the incident reflected laser light 149 that enters a gain medium of a laser within the laser assembly 140 as optical feedback, as will be described. Alternatively, a current signal may be generated by the laser assembly 140.

The optical pickup unit 123 may be caused to write data to the optical disc 136 by controlling the laser assembly 140 in the optical pickup unit 123 so as to form the data structures in the optical disc 136. The writing capabilities of the optical disc drive 100 may also be employed to write a label on a label surface of the optical disc 136. Specifically, the label surface of the optical disc 136 may be chemically treated so as to change an optical property such as optical density, reflectivity, or color upon being irradiated with laser light from the laser assembly 140. Such treatment includes, for example, a coating of thermo-chromic material that has been screen-printed or otherwise disposed on the label surface such that this material changes from light to dark color when activated by laser light 146 from the laser assembly 140. The thermo-chromic material may comprise, for example, a mixture of color-forming dye, activator, and infrared antenna contained in a polymer matrix. The infrared antenna absorbs laser energy of a particular wavelength or range of wavelengths and converts it to heat. The heat causes the activator, dye, and the polymer matrix to melt, thereby allowing the activator to interact with the dye. The interaction results in a chemical change to the dye that causes a change in color. The label material may vary slightly from manufacturer to manufacturer, from one disc to another disc from the same manufacturer, or even from one region on a disc to another region on the same disc. As a consequence, the appearance of the generated label may vary accordingly.

The spindle 129 comprises a motor or other such device that spins the optical disc 136. This motor may be, for example, a brushless DC motor or other type of motor. In this respect, the optical disc 136 is mounted onto the spindle 129. Thereafter, the optical disc 136 may be spun relative to the optical pickup unit 123 and the rotational position laser sensor 133. The rotational position laser sensor 133 obtains positional data from a position encoder 159 on the optical disc 136 as it rotates on the spindle 129. By virtue of the positional data obtained from the position encoder 159, the precise azimuth location of the optical pickup unit 123 relative to the optical disc 136 can be tracked during the operation of the optical disc drive 100.

The optical disc drive 100 further comprises a number of components stored in the memory 116 and executable by the processor 113 in order to control the operation of the various components of the optical disc drive 100. These components comprise, for example, an operating system 163 and a disc drive controller 166. The disc drive controller 166 is executed by the processor 113 to control the various operations of the optical disc drive 100. In this respect, the disc drive controller 166 orchestrates the general operation of the optical disc drive 100 in writing data to and reading data from optical discs 136. The disc drive controller 166 also orchestrates the operation of the optical disc drive 100 in writing a label on a surface of an optical disc 136.

Where embodied in the form of software or firmware, the disc drive controller 166 and the laser focus actuator control 169 may be implemented using any one of a number of programming languages such as, for example, C, C++, Assembly, or other programming languages. The disc drive controller 166 may be implemented, for example, in an object oriented design or in some other programming architecture. Where any portion of the disc drive controller 166 and/or the laser focus actuator control 169 is represented in a flow chart herein, assuming that the functionality depicted is implemented in an object oriented design, for example, then each block of such flow charts may represent functionality that is implemented in one or more methods that are encapsulated in one or more objects, etc.

The memory 116 may comprise, for example, random access memory (RAM), such as, for example, static random access memory (SRAM), dynamic random access memory (DRAM), or magnetic random access memory (MRAM) and other such devices. In addition, the memory 116 may also include, for example, read-only memory (ROM) such as a programmable read-only memory (PROM), an erasable programmable read-only memory (EPROM), an electrically erasable programmable read-only memory (EEPROM), or other like memory device.

In addition, the processor 113 may represent multiple processors and the memory 116 may represent multiple memories that operate in parallel. In such a case, the local interface 119 may be an appropriate network that facilitates communication between any two of the multiple processors, between any processor and any one of the memories, or between any two of the memories etc. The processor 113 may be of electrical, optical, or molecular construction, or of some other construction as can be appreciated by those with ordinary skill in the art.

The operating system 163 is executed to control the allocation and usage of hardware resources such as the memory, processing time and peripheral devices in the optical disc drive 100. In this manner, the operating system 163 serves as the foundation on which applications depend as is generally known by those with ordinary skill in the art.

Next, the general operation of the optical disc drive 100 in reading from or writing to the optical disc 136 is described according to an embodiment of the present invention. The disc drive controller 166 controls the operation of the various components of the optical disc drive 100 in order to read from or write to the optical disc 136. The disc drive controller 166 also controls the operation of the various components of the optical disc drive 100 when writing data to and reading data from the optical disc 136.

To the extent that the disc drive controller 166 orchestrates the operation of the various components of the optical disc drive 100 in order to read data from or write data to the optical disc 136, it controls the movement of the optical pickup unit 123 by directing the actuator 126 to cause the optical pickup unit 123 to move along the screw shaft 139 as needed. In addition, the disc drive controller 166 controls the rotation of the optical disc 136 by controlling the speed of the spindle 129.

The laser assembly 140 performs the dual operations of both a light source and a sensor. Specifically, the laser assembly 140 is configured to write data to the optical disc 136 by acting as a light source, and to read data from the optical disc 136 by acting as a sensor. The disc drive controller 166 controls the write functions of the optical disc drive 100 by directing the laser assembly 140 to generate the laser light 146 of sufficient power to cause pits or other data marks to be formed at appropriate locations in the optical disc 136 to represent data as can be appreciated. The disc drive controller 166 controls the read functions by directing the laser assembly 140 to generate relatively lower power laser light 146 that is insufficient to cause the formation of data marks. The corresponding reflected laser light 149 that reenters the gain media of a laser within the laser assembly 140 acts as optical feedback that varies in amplitude or phase, or both, as the laser light 146 falls incident onto the data marks, and results in the generation of a data signal that represents the data embodied in the optical disc 136.

Also, the rotational position laser sensor 133 comprises a laser that generates laser light 161 that is directed to the position encoder 159. When the laser light 161 falls incident to a land portion of the position encoder 159 (as opposed to pits that cause the laser light 161 to be absorbed, diffracted, or otherwise attenuated), at least a portion of the laser light 161 is reflected in the form of reflected laser light 162 that is directed back to the rotational position laser sensor 133. In a manner similar to the laser assembly 140, the reflected laser light 162 reenters the gain media of the rotational position laser sensor 133 and acts as optical feedback resulting in the generation of a position signal that represents position encoder 159 data embodied in the optical disc 136.

The disc drive controller 166 tracks the position of the optical disc 136 based upon the position signal from the rotational position laser sensor 133. In particular, the rotational position laser sensor 133 senses the passing of position encoder 159 in the form of, for example, encoder bars disposed on the optical disc 136 near, for example, the inside diameter, although the encoder bars may be located at some other position on the optical disc 136. To track the actual location of the optical disc 136, the disc drive controller 166 may include a counter that counts pulses of the position signal up to a total number of pulses in a single rotation to determine the actual position of the optical disc 136 at a given time.

Thus, the azimuthal location of the laser beam 146 generated by the optical pickup unit 123 relative to the optical disc 136 may be determined at any given time by virtue of the positional data tracked by the disc drive controller 166 based upon the data generated by the rotational position laser sensor 133. In particular, the azimuthal location of the optical pickup unit 123 relative to a predefined position on the optical disc 136 of each pixel or segment of a label that is to be written to the optical disc 136 may be calculated based upon the relative positions of each of the encoder bars of position encoder 159 sensed by the rotational position laser sensor 133.

By virtue of the above-mentioned components, the disc label controller 163 orchestrates writing to and reading from the optical disc 136. In addition, the disc drive controller 166 causes the optical pickup unit 123 to position the lens 156 to properly condition the laser light 146 as it is directed at the optical disc 136. In this respect, the positioning of the lens 156 may be performed continuously while the optical disc 136 spins and the laser 143 is directed thereto during the performance of label writing functions, or other operations. Conditioning the laser light 146, in some embodiments, includes focusing the laser light 146 on the desired location of the optical disc 136.

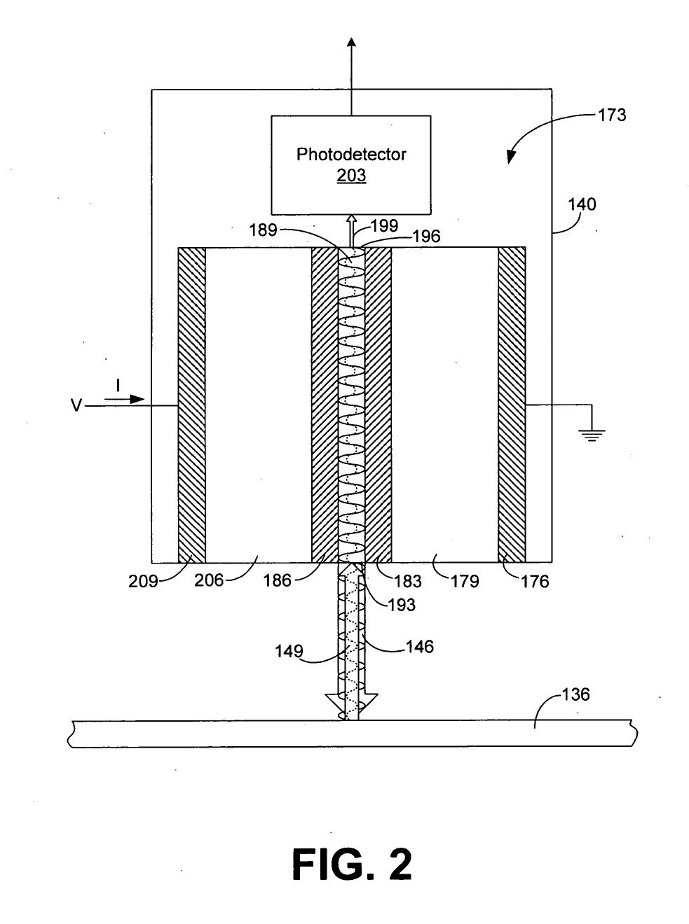

Turning then to FIG. 2, shown is an example of the laser assembly 140 as it is employed to generate a data signal when reading data from the optical disc 136 according to an embodiment of the present invention. In the example illustrated, the laser assembly 140 includes a laser 173 that comprises, for example, a laser diode of several layers. Alternatively, the laser 173 may comprise some type of laser other than a laser diode.

The layers of the laser 173 include a ground electrode 176 and a substrate 179. Disposed on the substrate 179 is a guiding layer 183. The laser 173 also includes a second guiding layer 176. Between the guiding layers 183 and 186 is a gain medium 189. The gain medium 189 includes a forward facet 193 and a rear facet 196. Both the forward and rear facets 193 and 196 are at least partially reflective, allowing the laser 173 to generate laser light 146. In particular, the forward and rear facets 193 provide internal feedback of optical power that facilitates the generation of laser light as can be appreciated.

In this respect, the forward facet 193 is partially reflective thereby enabling laser light 146 to be emitted when the laser drive input current reaches a predefined level generally referred to as a “threshold current” as will be described. The laser assembly 140 also includes a photodetector 203. A predefined percentage of the output power generated by the laser is transmitted as laser light 199 that exits the rear facet 196 of the laser 173 and is directed to the photodetector 203. The photodetector 203 generates an output signal that may be, for example, a data signal or other signal based upon the information obtained from the optical disc 136. This signal is transmitted to the processor circuit 106 (FIG. 1) as described above.

The laser 173 also includes a cladding layer 206 and a positive electrode 209. Generally, the example structure of the laser 173 is typical of the structures of the laser diodes in this respect and is not described herein in detail.

When power is applied to the laser 173, the laser 173 emits optical power in the form of the laser light 146 toward the optical disc 136. Also, the laser 173 emits optical power in the form of the laser light 199 through the rear facet 196 to the photodetector 203. In one embodiment, the magnitude of the optical output power emitted by the laser 173 is a function of the external optical feedback coupled into the gain medium of the laser 173.

The “power efficiency” of the laser 173 is defined herein as the optical output power divided by the electrical input current, and the “gain” of the gain medium of the laser 173 is defined as optical output power divided by optical input power. When the optical power is emitted from the front facet 193 in the form of the laser light 146, the laser light 146 may strike a reflective surface associated with the optical disc 136. Consequently, at least a portion of the laser light 146 is reflected as the reflected laser light 149 back toward the gain medium 189 of the laser 173. According to the various embodiments of the present invention, the reflected laser light 149 is coupled back into the gain medium 189. In this respect, the reflected laser light 149 that enters the gain medium 189 acts as external optical feedback into the laser 173. While an optical disc 136 is shown as reflecting the laser light 146, it is understood that any optical medium that allows reflection of the laser light 146 back into the gain medium 189 may be employed.

In this respect, the laser 173 may include two types of feedback. First, is the internal feedback inherent by the use of the forward and rear facets 193 and 196. In this respect, laser light moves back and forth between the forward and rear facets 193 and 196 gaining strength by causing the stimulated emission of radiation as can be appreciated. The laser light moves back and forth between the forward and rear facets 193 and 196 until sufficient power is reached.

The forward facet 193 and rear facet 196 may be dielectrically coated or may be constructed in some other manner so as to provide the desired amount of reflectivity for the internal feedback, while at the same time allowing the emission of the desired amount of optical power therethrough as can be appreciated. The external optical feedback comprises the amount of reflected laser light 149 that re-enters the gain medium 189 of the laser 173.

When the laser 173 is operated at near threshold levels, the external optical feedback provided by the reflected laser light 149 that enters the gain medium 189 may cause an appreciable change in the gain of the gain medium causing the laser to make a transition from operation below threshold to operation above threshold and significantly increasing the optical power emitted by the laser 173 as both the laser light 146 and the laser light 199 emitted through the rear facet 196 and directed to the photodetector 203. Thus, when the external optical feedback exists such that the reflected laser light 149 re-enters the gain medium 189, then a greater amount of optical power is detected at the photodetector 203.

Conversely, when no reflected laser light 149 is directed back into the gain medium 189 then the optical power detected by the photodetector 203 is correspondingly diminished. Thus, the laser assembly 140 may be employed as a sensor that generates a data signal based upon data structures embodied in the optical disc 136. In particular, when the laser light 146 falls onto a “land” portion of the optical disc 136 that represents, for example, a logical “1”, the resulting reflected laser light 149 enters the gain medium 189, thereby resulting in a greater amount of emitted optical power from the laser 173. Also, a greater amount of optical power is emitted through the rear facet 196 toward the photodetector 203. The photodetector 203 can thus output a signal indicative of the logical “1” based on the detection of a greater amount of laser light 199 incident on the photodetector 203.

Conversely, when the laser light 146 strikes a “pit” on the optical disc 136, then there is little or no reflected laser light 149 that enters the gain medium 189. Consequently, the amount of laser light 199 that is emitted through the rear facet 196 is correspondingly diminished due to the absence of external optical feedback. In response, the photodetector 203 generates a diminished signal. Thus, the pits of the optical disc 136 may represent, for example, a logical “0” for which a corresponding signal may be generated by the photodetector 203 and transmitted to the processor circuit 106 (FIG. 1). In addition, much higher efficiency data coding schemes than the above described example may be used. For instance, the passage of the edges of pits through a laser beam causes transitions in a data signal, the locations of the transitions in time determining the digital data according to a data encoding scheme.

The use of the laser assembly 140 provides a distinct advantage in that the laser assembly 140 may be employed to write data or a label to the optical disc 136, and, the same laser assembly 140 may be employed as a sensor to generate a data signal from a data structure embodied within the optical disc 136. Consequently, there is no need for a separate sensor within the optical disc drive 100 beyond the photodetector 203 within the laser assembly 140 to perform the function of reading data from the optical disc 136. Among other functions, the photodetector 203 may typically be employed to generate a laser power monitor signal that is used to control the output of the laser 173. Consequently, laser assemblies 140 are commonplace and may be obtained at relatively low cost.

This presents a significant advantage in that the cost associated with a separate sensor is avoided. Thus, the photodetector 203 comprises, for example, a circuit that generates a data signal that embodies the data within the optical disc 136 based upon the variation in the power efficiency of the laser assembly 140 due to the external optical feedback of the reflected laser light 149 that is directed into the gain medium 189 of the laser 173.

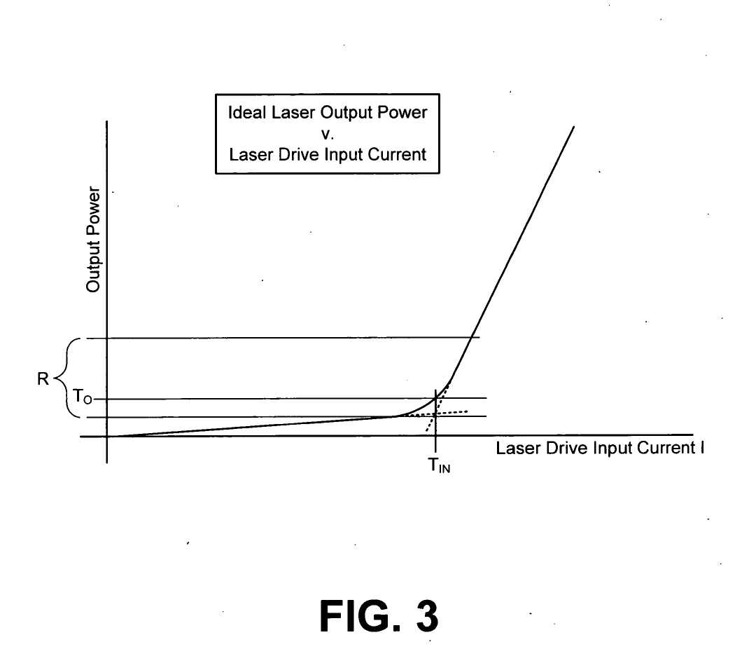

Referring next to FIG. 3, shown is a graph of the emitted output power of the laser assembly 140 in response to the laser drive input current I of the laser assembly 140. In this respect, the laser drive input current I is the drive current applied to the laser 173 (FIG. 2) of the laser assembly 140 by external control circuitry as can be appreciated. As shown, emitted output power of the laser 173 is relatively low until at least a threshold laser drive current T_{IN} is applied. This threshold laser drive current T_{IN} marks a substantial and dramatic change in the slope of the emitted output power relative to the laser drive input current. This slope determines the power efficiency of the laser.

Note that there may be several different approaches to determining the threshold laser drive current as can be appreciated, where that depicted in FIG. 3 is provided as an example. In this respect, depending on the method used for defining and determining the threshold, the threshold laser drive current may be located at several different locations near the elbow of the output power curve as can be appreciated.

According to one embodiment of the present invention, the laser drive input current I applied to the laser 173 in order to read data from the optical disc 136 is set near the threshold laser drive current T_{IN}. In this respect, the external optical feedback presented by the reflected laser light 149 that is coupled back into the gain medium 189 of the laser 173 results in a relatively significant change in the gain of the laser 173 causing it to transition from operating below threshold to operating above threshold. Note that once the laser is operating above threshold its gain stabilizes, and the gain is no longer influenced by additional optical feedback. Consequently, when drive current T_{IN} is applied to the laser 173, laser output power generally increases rapidly and nonlinearly as a function of any optical feedback until the threshold is reached, and the laser output power increases substantially in proportion to additional optical feedback thereafter. Specifically, according to one embodiment, the emitted output power of the laser 173 falls within an operating range R for an applied drive current T_{IN}, external optical feedback from pits and lands, and the resultant variation in the gain of the laser 173. In another embodiment, the operating range R of the emitted output power of the laser 173 straddles the emitted output power T_{O} at the threshold laser drive current T_{IN}. In this respect, the lowest and highest values of the emitted output power of the laser 173 due to the selective application of the external feedback straddles or fall on either side of the output power of the laser 173 at the threshold laser drive current T_{IN}.

Because the magnitude of the laser light 199 directed toward the photodetector 203 varies based upon the gain of the laser 173 as influenced by the external optical feedback from pits and lands, the photodetector 203 generates a data signal in response. The optical power emitted through the rear facet 196 varies in response to both the gain of the laser 173 and the optical feedback power coupled into the laser. Thus laser output increases rapidly as a function of optical feedback near threshold. In this respect, the rear facet 196 is conditioned to provide for the emission of a predefined fraction of the total optical power emitted by the laser 173.

Because the operating range R of the output power results in emitted laser outputs that straddle the threshold laser drive current I of the laser 173, a dramatic difference in the output of the laser 173 is seen in response to the application of the external optical feedback in the form of the reflected laser light 149 that is coupled to the gain medium 189 of the laser 173.

Referring back to FIG. 2, according to the various embodiments of the present invention, the data signal generated by the laser assembly 140 based upon the data embodied in the optical disc 136 may be generated using one of a number of approaches. In one approach, a power source is coupled to the laser 173 that applies a substantially constant laser drive current to the laser 173. In one embodiment, this substantially constant laser drive input current is the threshold laser drive current T_{IN} (FIG. 3). The output of the photodetector 203 is thus proportional to the gain of the laser 173. Because the gain changes based upon the external feedback provided by the reflected laser light 149 reflected from the optical disc 136, the data signal may be generated from such gain changes. In this respect, the external optical feedback represented by the reflected laser light 149 is modulated by the data embodied in the optical disc 136. Consequently, the data embodied in the optical disc 136 in turn modulates the output signal of the photodetector 203.

In another approach, additional circuitry may be used to maintain the portion of the optical power 199 directed to the photodetector 203 at a predefined constant value. To do so, the laser drive input current is varied so as to maintain a substantially constant emitted output power 199 directed to the photodetector 203. An appropriate feedback loop may be used to accomplish the substantially constant emitted output power 199 from the rear facet 196 as can be appreciated. A data signal may then be generated based upon the changes in magnitude of the laser drive current applied to the laser 173. In addition, the laser assembly 140 may be operated in other modes that provide for the generation of the data signal that embodies the data of the optical disc 136 as can be appreciated.

In another embodiment, a laser drive input current may be applied to the laser that embodies an AC current. The AC current may be in the form, for example, of a sine wave. The AC current may be specified so that the threshold current of the laser 173 is between the highest and lowest magnitudes of the AC current. In this respect, the AC current would straddle the threshold current of the laser. This would provide an approach by which the location of the threshold current of the laser 173 may be detected and by which the range of input current applied to the laser may be controlled to straddle the threshold current of the laser. Controlling the operating range of the laser in this manner enables the sensitivity of the sensor to remain large and relatively constant as the laser threshold current changes due to temperature variations and other causes. Specifically, if the AC current straddles the threshold current in this manner, then the optical output of the laser 173 will vary significantly with the positive and negative peaks of the AC current due to the significant change in the optical output power of the laser 173 when passing through the threshold current. To detect the threshold current of the laser 173, a DC offset of the AC current applied to the laser drive input current can be varied until the appropriate change in laser output power is detected. Alternatively, a duty cycle of the output waveform may be examined.

Additionally, the laser light 149 may not be in phase relative to the laser light 146 when it is reflected back into the gain medium 189 of the laser 173. This is because the distance between the optical disc 136 and the front facet 193 may vary due to, for example, warpage as the optical disc 136 spins relative to the laser 173. Consequently, the data signal generated by the laser assembly 140 as described above may experience fluctuations such as a sinusoidal or other fluctuation from constructive and destructive interference caused by the change in the phase of the reflected laser light 149.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. A system for generating a data signal, comprising:
a laser having a gain medium and configured to emit optical output power, the laser being further configured to receive an external optical feedback optically coupled into the gain medium from an optical medium, wherein the external optical feedback is modulated by data embodied in the optical medium; and
a circuit that generates the data signal corresponding to the data embodied in the optical medium based upon a variation in the optical output power of the laser due to the external optical feedback optically coupled into the gain medium.

2. The system of claim 1, wherein the optical output power falls within an operating range corresponding to a range of the variation in the external optical feedback.

3. The system of claim 2, wherein the operating range straddles an optical output power at a threshold laser drive current without the external optical feedback.

4. The system of claim 1, wherein the circuit further comprises a photodetector optically coupled to the laser, wherein a predefined percentage of the optical output power is directed to the photodetector.

5. The system of claim 4, wherein the photodetector generates the data signal in response to the predefined percentage of the optical output power directed to the photodetector, the magnitude of the optical output power being a function of the external optical feedback coupled into the gain medium of the laser.

6. The system of claim 5, wherein the laser further comprises:
a forward facet at a first end of the gain medium;
a rear facet at a second end of the gain medium, wherein the predefined percentage of the optical power is emitted through the rear facet; and
the photodetector being optically coupled to the rear facet.

7. The system of claim 5, further comprising a power source coupled to the laser, the power source applying a substantially constant laser drive input current to the laser.

8. The system of claim 4, further comprising circuitry that varies a laser drive input current to maintain the percentage of the optical output power directed to the photodetector at a predefined constant value.

9. The system of claim 8, wherein the circuit that generates the data signal embodying the data based upon the variation in output optical power of the laser due to the external optical feedback optically coupled into the gain medium of the laser further comprises circuitry that generates the data signal based upon a magnitude of the laser drive input current.

10. The system of claim 1, wherein the optical medium is positioned relative to the laser such that at least a portion of the optical medium reflects at least a portion of the optical power emitted from the laser back into the gain medium of the laser.

11. The system of claim 10, wherein the optical medium further comprises an optical disc.

12. The system of claim 1, wherein the laser and the circuit are configured to detect a rotational position of a position encoder on an optical disc so as to identify a rotational position of the optical disc relative to the laser.

13. A method for generating a modulated signal embodying data stored on an optical medium, comprising:
emitting optical power from a laser;
applying an external optical feedback into a gain medium of the laser using an optical medium, wherein the external optical feedback is modulated by data embodied in the optical medium; and
generating a signal embodying the data based upon a variation in the optical output power of the laser due to the application of the external optical feedback into the gain medium of the laser.

14. The method of claim 13, further comprising applying to the laser a laser drive current that approximates a laser threshold current, wherein the range of the output power of the laser due to the variation in optical feedback coupled into the gain medium of the laser straddles an output power of the laser at the laser threshold current without the external optical feedback.

15. The method of claim 13, further comprising:
directing a predefined percentage of the optical power emitted from the laser onto a photodetector; and
wherein the generating the signal further comprises generating the signal with the photodetector in response to the optical output power directed onto the photodetector, wherein the optical power directed onto the photodetector varies as a function of the external optical feedback coupled into the gain medium of the laser.

16. The method of claim 15, further comprising applying a substantially constant laser drive input current to the laser.

17. The method of claim 15, further comprising applying a varying laser drive input current to the laser that embodies an AC current that straddles a threshold current of the laser.

18. The method of claim 13, further comprising:
directing a portion of the optical power emitted from the laser onto the photodetector, wherein the portion of the optical power directed to the photodetector is substantially constant; and
wherein the generating the signal further comprises generating the signal based upon a laser drive input current to the laser.

19. The method of claim 18, further comprising varying the laser drive input current in response to a signal generated by the photodetector.

20. The method of claim 13, wherein the applying an external optical feedback into a gain medium of the laser using an optical medium further comprises reflecting at least a portion of the optical power emitted by the laser back into the gain medium of the laser using the optical medium, wherein the optical medium comprises an optical disc.

21. A system for generating a data signal, comprising:
a laser having a gain medium and emitting optical power;
means for applying external optical feedback to the gain medium and for modulating the external optical feedback with data; and
means for generating the data signal embodying the data based upon a variation in the external optical feedback.

22. The system of claim 21, further comprising means for generating and applying a laser drive current to the laser that approximates a laser threshold current, wherein the range of the output power of the laser due to the variation in external optical feedback applied to the gain medium of the laser straddles an output power of the laser at the laser threshold current without the external optical feedback.
